(19) United States
(12) Patent Application Publication
(10) Pub. No.: US 2021/0033994 A1
(43) Pub. Date: Feb. 4, 2021

(54) IMAGE FORMING METHOD

(71) Applicant: Konica Minolta, Inc., Tokyo (JP)

(72) Inventors: Michiyo FUJITA, Tokyo (JP); Ryuichi HIRAMOTO, Hyogo (JP); Kaori MATSUSHIMA, Tokyo (JP); Tomoko MINE, Tokyo (JP)

(21) Appl. No.: 16/908,115

(22) Filed: Jun. 22, 2020

(30) Foreign Application Priority Data
Aug. 1, 2019 (JP) 2019-141971

(51) Int. Cl. G03G 9/083; G03G 15/02; G03G 15/08; G03G 9/09

(52) U.S. Cl. CPC G03G 9/0832; G03G 9/09; G03G 15/08; G03G 15/0241

(57) ABSTRACT

Provided is an image forming method for arranging powder particles on a resin image layer, wherein the powder particles are non-spherical powder particles; the image forming method containing the step of adjusting an orientation of the powder particles disposed on the resin image layer; and hd1 and hd2 are adjusted so as to satisfy a relation expressed by the following Equation (1), Equation (1): hd1<hd2, wherein hd1 and hd2 each are respectively a half-value width of a reflected light distributions before and after the step of adjusting the orientation of the powder particles.

### CROSS-REFERENCE TO RELATED APPLICATION

The entire disclosure of Japanese Patent Application No. 2019-141971 filed on Aug. 1, 2019 with Japan Patent Office is incorporated herein by reference in its entirety.

### BACKGROUND

### Technological Field

The present invention relates to an image forming method. In particular, the present invention relates to an image forming method capable of forming an image having a high metallic luster feeling and a high glitter feeling when powder particles having a metallic luster are used, and capable of forming an image having a granular feeling when powder particles having no metallic luster are used.

### Description of the Related Art

In recent years, in the on-demand printing market, the demand for feature printing and high value-added printing is increasing. Above all, requests for metallic printing and pearl printing are particularly large, and various studies have been conducted. As one of the methods, a method of transferring a metal foil or a resin foil using a toner as an adhesive layer has been studied. For example, Patent Document 1 (JP-A 01-200985) proposes a method of forming a toner image and adhering a transfer foil only to the toner portion. In this method, when the foil is transferred to only a part of the image, there is a problem that all the remaining foil is wasted. In addition, when printing a plurality of metallic expressions such as mirror tone and glitter tone, it was necessary to prepare different foils respectively. On the other hand, studies have also been made to add a bright pigment to a toner. For example, in Patent Document 2 (JP-A 2014-157249), there is proposed a method of forming a metallic image only on a necessary portion by containing a bright pigment in a toner. However, this method has not reached the required metallic feeling and pearly feeling.

### SUMMARY

The present invention has been made in view of the above problems and circumstances, An object of the present invention is to provide an image forming method capable of forming an image having a high metallic luster feeling and a high glitter feeling when powder particles having a metallic luster are used, and capable of forming an image having a granular feeling when powder particles having no metallic luster are used.

In order to solve the above-mentioned problems, the present inventor has found that, in the process of examining the cause of the above-mentioned problems, by adjusting the half-value width of the reflected light distribution before and after the process of adjusting the orientation of the non-spherical powder particles arranged on the resin image layer so as to satisfy a specific relationship, it is possible to form an image having a high metallic luster feeling and a high glitter feeling. That is, the above-mentioned problem according to the present invention is solved by the following means.

To achieve at least one of the abovementioned objects, an image forming method that reflects an aspect of the present invention is as follows.

An image forming method for arranging powder particles on a resin image layer, wherein the powder particles are non-spherical powder particles; the image forming method comprising the step of adjusting an orientation of the powder particles disposed on the resin image layer; and hd1 and hd2 are adjusted so as to satisfy a relation expressed by the following Equation (1),

hd1<hd2, Equation(1):

wherein hd1 and hd2 each are respectively a half-value width of a reflected light distributions before and after the step of adjusting the orientation of the powder particles.

According to the above-mentioned means of the present invention, it is possible to provide an image forming method capable of forming an image having a high metallic luster feeling and a high glitter feeling when powder particles having a metallic luster are used, and capable of forming an image having a granular feeling when powder particles having no metallic luster are used. The expression mechanism or action mechanism of the effect of the present invention is not clarified, but is inferred as follows. By pressing the powder particles of non-spherical shape supplied on the resin image layer using a member whose surface is not smooth against the image that is oriented in a substantially horizontal state with respect to the resin image layer, the powder particles are non-uniformly pressed. As a result, it is possible to disturb the orientation state of the powder particles. The fact that the powder particles do not deform but disturb the orientation of the powder particles means that the angles of the powder particles are mixed at various angles. Since the angle of the powder particles is oriented in various directions, each of the powder particles is specularly reflected when viewed microscopically, changing the angle yields a sparkling image. Therefore, in the present invention embodiment, when the half-value widths of the reflected light distributions before and after the step of adjusting the orientation of the non-spherical powder particles arranged on the resin image layer are defined as hd1 and hd2, the orientation of the powder particles is adjusted to satisfy the relation expressed by the above Equation (1), so that when the powder particles having the metallic luster are used, it is inferred that an image having a high metallic luster feeling and a high glitter feeling may be formed, and when the powder particles having no metallic luster are used, an image having a granular feeling may be formed.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a diagram schematically illustrating a configuration of a surface treatment apparatus and an electrophotographic image forming system having the same according to the present invention;

FIG. 2 is a diagram schematically illustrating a surface treatment apparatus according to the present invention; and

FIG. 3A is a diagram for explaining a pressing step according to the present invention.

FIG. 3B is a diagram for explaining a pressing step according to the present invention.

FIG. 3C is a diagram for explaining a pressing step according to the present invention.

### DETAILED DESCRIPTION OF THE EMBODIMENTS

Hereinafter, one or more embodiments of the present invention will be described with reference to the drawings. However, the scope of the invention is not limited to the disclosed embodiments.

The image forming method of the present invention is an image forming method for arranging powder particles on a resin image layer, wherein the powder particles are non-spherical powder particles, the image forming method has a step of adjusting the orientation of the powder particles arranged on the resin image layer, and the adjustment is performed so as to satisfy the relation ex pressed by the above Equation (1) when the half-value widths of the reflected light distributions before and after the step of adjusting the orientation of the powder particles are respectively hd1 and hd2. This feature is a technical feature common to or corresponding to each of the following embodiments.

In an embodiment of the present invention, it is preferable that the non-spherical powder particles are flat powder particles from the viewpoint of expressing the effect of the present invention. In addition, it is preferable to include a step of supplying the powder particles onto the resin image layer formed on the recording medium. Further, it is preferable that the resin image layer is a toner image layer formed by electrophotography, from the viewpoint of easily forming a resin image of an arbitrary color at an arbitrary position and increasing the value of the final image.

Further, it is preferable that the step of softening the resin image layer is included in order to reliably adhere the powder particles to the resin image layer. The step of adjusting the orientation of the powder particles is preferably accompanied by pressing, in that the powder particles may be disturbed to a desired orientation state.

It is preferable that the surface shape of the pressing member used in the step of adjusting the orientation of the powder particles is such that an average height Rc of the roughness curve element is in the range of 0.005 to 2.000 mm and an average length RSm of the roughness curve element is in the range of 0.005 to 2.000 mm in order to disturb the powder particles to a desired orientation state.

It is preferable that the powder particles have a metallic luster because an image having a high metallic luster and a high glitter can be formed.

Hereinafter, the present invention, its constituent elements, and configurations and embodiments for carrying out the present invention will be described. In the present application, “to” is used in the meaning that the numerical values described before and after are included as a lower limit value and an upper limit value.

### [Image Forming Method]

The image forming method of the present invention is an image forming method for arranging powder particles on a resin image layer, wherein the powder particles are non-spherical powder particles, the method includes a step of adjusting the orientation of the powder particles arranged on the resin image layer, and the adjustment is performed so as to satisfy the relation expressed by the following Equation (1) when the half-value widths of the reflected light distributions before and after the step of adjusting the orientation of the powder particles are respectively hd1 and hd2.

hd1<hd2 Equation (1):

Further, it is preferable that the image forming method of the present invention further includes a step of forming a resin image layer on a recording medium (a resin image layer forming step), a step of adjusting a resin image layer to a state in which the resin image layer is softened (a softening step), a step of supplying the non-spherical powder particles onto the softened resin image layer (a powder supply step), a step of rubbing the surface of the resin image layer supplied with the powder particles (a rubbing step), or a step of transferring the surface of the resin image layer in which the powder particles are oriented to the orientation member in advance as a powder supply step (a powder transfer step). When a powder transfer step is used as the powder supply step, the step of rubbing the surface of the resin image layer (a rubbing step) may be omitted. Hereinafter, each step will be described.

### <Orientation Adjustment Step>

The orientation adjustment step is a step of adjusting the orientation of the powder particles arranged on the resin image layer, and at this time, the orientation is adjusted so as to satisfy the relationship expressed by the above Equation (1).

### (Half-Value Width of Reflected Light Distribution)

The half-value widths of the reflected light distributions according to the present invention may be calculated by measuring the reflected light distributions using a goniophotometer GP-5 (manufactured by Murakami Color Research Institute, Ltd.) and analyzing the measured data with analysis software GPG1_WIN. The measurement conditions are as follows. A half-value width refers to a full width at half maximum, and it is a numerical value twice the half width at half maximum (AF) calculated by the analysis software.

### (Measurement Conditions)

IA: 45°

FA: 0.0°

R1: 0°

R2: +90°

Data Correction: Sample

It is more preferable that the half-value widths hd1 and hd2 are adjusted so as to satisfy the following Equation (2).

0.5<hd2−hd1<20 Equation (2):

The half-value width hd1 and the half-value width hd2 are adjusted so as to satisfy the relation of Equation (1) by adjusting the orientation of the powder particles disposed on the resin image layer. Specifically, the step of adjusting the orientation of the powder particles is preferably accompanied by pressing. By pressing the powder particles arranged on the resin image layer, the orientation state of the powder particles is disturbed, and the half-value width may be adjusted to a desired range. Here, the “pressing” refers to pressing the surface of the resin image layer in a direction intersecting with respect to the surface of the resin image layer (e.g., a vertical direction).

The surface shape of the pressing member used in the orientation adjustment step is preferably made to have an average height Rc of the roughness curve element in the range of 0.005 to 2.000 mm, and an average length RSm of the roughness curve element in the range of 0.005 to 2.000 mm. More preferably, the average height Rc is in the range of 0.010 to 1.000 mm and the average length RSm is in the range of 0.500 to 1.500 mm.

### (Average Height Rc, Average Length RSm)

The average height Rc and the average length RSm of the roughness curve element are calculated by measuring the shape using a one-shot 3D shape measuring apparatus VR-3200 manufactured by KEYENCE Co., Ltd., shape measurement is performed under conditions of a high magnification camera and a magnification of 40 times, and line roughness is measured. It is determined by measuring Rc and RSm for a total of 6 horizontal lines and 3 vertical lines, and averaging the values.

The pressing member according to the present invention is not particularly limited, and may be appropriately selected from various materials such as metal, resin, wood, stone, cloth, paper, and ceramic, or composite materials thereof. A coating layer such as a releasing agent or an antistatic agent may be applied to the surface of the pressing member.

The temperature at the time of pressing with the pressing member is preferably in the range of 40 to 200° C., the pressing time is preferably in the range of 0.010 to 20 seconds, and the pressing force is preferably in the range of 1 to 500 kPa.

### <Resin Image Layer Forming Step>

The resin image layer forming step is a step of forming a resin image layer on the recording medium. This step may be performed by a usual electrophotographic image forming method.

### <Softening Step>

The softening step is a step of adjusting the resin image layer to a softened state. The resin image layer may be adjusted to a state in which the resin image layer is softened at least during rubbing of the surface of the resin image layer by a rubbing step described later, or may be adjusted to a state in which the resin image layer is softened during powder transfer by a powder transfer step described later. The method of adjusting the resin image layer to the softened state is not particularly limited, and for example, the resin image layer may be heated, the excessively heated resin image layer may be cooled, the heated resin image layer may be kept warm, or a softening agent may be applied to the resin image layer. The resin image layer adjusted to the softened state exhibits adhesiveness to such an extent that the powder particles supplied onto the surface of the resin image layer are oriented by rubbing, and thereafter adhere to the surface, or exhibits adhesiveness to such an extent that the powder particles migrate to the resin image layer at the time of powder transfer.

The temperature at which the resin image layer softens in the rubbing step (hereinafter also referred to as “rubbing temperature”) may be obtained, for example, by gradually increasing the temperature of the resin image layer and the recording medium at normal temperature and detecting the temperature at which the powder particles start to stick to the surface of the resin image layer. More specifically, the rubbing temperature may be determined by a method in which a hot plate is heated to a predetermined temperature, a recording medium is placed on the hot plate so that a resin image layer (image plane) faces upward, powder particles to be used are adhered to an appropriate coating member (for example, a sponge portion of an eye shadow tip), and the surface of the resin image layer is slightly rubbed, and whether or not the powder particles adhere to the surface of the resin image layer is confirmed. In the above method, the set temperature of the hot plate is raised at predetermined intervals, for example, by 5° C., and the temperature at which the powder particles start to adhere to the surface of the resin image layer is searched for. The rubbing temperature may be set within an appropriate range from the temperature at which the powder particles start to adhere, for example, up to a temperature of +5° C. higher than the temperature at which the powder particles start to adhere. The temperature at which the resin image layer softens in the powder transfer step (hereinafter also referred to as “transfer temperature”) is, for example, a temperature at which powder particles are rubbing oriented on silicone rubber is disposed on the resin image surface, and the temperature at which the powder particles are transferred to the resin image layer may be determined by heating and pressing while increasing the set temperature of the hot plate by a predetermined interval, for example, by 5° C., and the temperature higher than the temperature may be set as the transfer temperature.

The method of applying the softening agent to the resin image layer is not particularly limited. Examples of the method of applying the softener to the resin image layer include a spraying method, a wire bar method, a doctor blade method, and a coating method using a roller. The softening agent applied to the resin image layer is not particularly limited as long as it softens the resin image layer. Examples of the softening agent include alcohols such as methanol and ethanol, ketones such as acetone and methyl ethyl ketone, hydrocarbon solvents such as pentane and hexane, and tetrahydrofuran.

The softening device is not particularly limited as long as it softens the resin image layer appropriately, but specifically, a temperature adjusting device or a softening agent coating device may be used.

The temperature adjusting device may be a heating device, a cooling device, or a device having both functions. The temperature adjusting device may utilize known devices, examples of which include hot plates, ovens, light irradiators, and blowers.

The softening agent application device is a device for applying a softening agent to a surface of a resin image layer. The softening agent application device may be a spray application device for applying the softening agent in a mist form, or may be a roller application device for applying the softening agent by a roller. Alternatively, a wire bar or a doctor blade may be used.

### <Powder Supply Step>

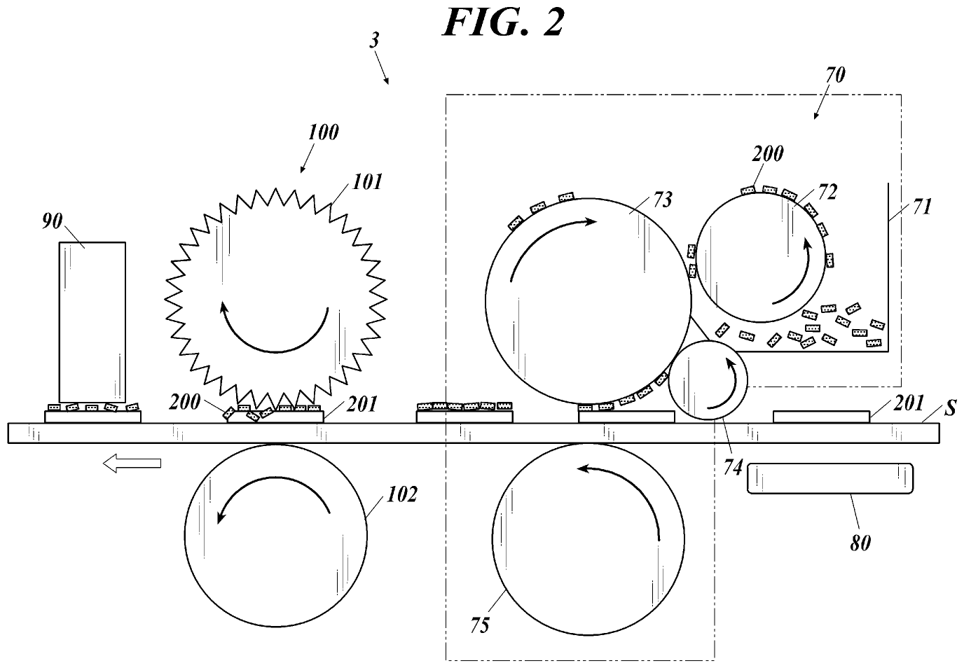

The powder supply step is a step of supplying powder particles to the surface of the resin image layer. The means for supplying the powder particles is not particularly limited as long as it is a device capable of supplying the powder particles to the surface of the resin image layer. As the device, a known device may be used according to the properties of the powder particles, and for example, the powder supply device may be a powder supply means described in JP-A 2013-178452 or a shown in FIG. 2 described later. Alternatively, a powder transfer step may be employed in which the powder particles previously oriented to the orientation member are transferred to the surface of the resin image layer.

The amount of the powder particles supplied to the resin image layer is not particularly limited as long as it may express a desired texture, but is preferably in the range of 0.1 to 10 layers.

The powder particles may be selectively supplied only on the resin image layer, or may be supplied to the entire surface of the recording medium including not only the resin image layer but also a portion where the resin image layer is not formed.

### <Rubbing Step>

The rubbing step is a step of rubbing the surface of the resin image layer to which the powder particles are supplied. “Rubbing” means moving relative to the resin image layer along the surface of the resin image layer while contacting the surface of the resin image layer on the recording medium. It is preferable that the rubbing is accompanied by the pressing from the viewpoint of orienting the powder particles on the surface of the resin image layer, and from the viewpoint of strengthening the adhesion of the powder particles to the resin image layer.

In the rubbing, when the relative speed of the rubbing portion in the rubbing device with respect to the resin image layer is too slow, the orientation of the powder along the surface of the resin image layer may be insufficient, and when too fast, the adhesion of the powder particles may be insufficient, the orientation of the powder particles along the surface of the resin image layer may be insufficient, and the intended appearance of the mirror tone or pearl tone in the final image may be degraded. From the viewpoint of sufficiently adhering and orientation the powder particles on the surface of the resin image layer, the relative speed is preferably in the range of 5 to 500 mm/sec.

In addition, in the rubbing, when the contact width of the rubbing portion on the surface of the resin image layer is too narrow, when the rubbing portion moves along the surface of the resin image layer, variation in the direction of the powder particles tends to occur, and the orientation of the powder particles adhering to the resin image layer may become insufficient, and when the contact width is too wide, conveyance of the recording medium becomes difficult. From the viewpoint of sufficiently realizing the intended orientation of the powder particles adhering to the surface of the resin image layer and the conveying property of the recording medium, it is preferable that the contact width is within the range of 1 to 200 mm in the length in the moving direction of the rubbing portion with respect to the resin image layer.

Further, when the pressing force in the pressing is too low, the adhesion strength of the powder particles may be weakened, and when it is too high, the resin image layer itself may be disturbed, and the torque at the time of conveying the recording medium may be increased. From the viewpoints of smooth realization and labor saving of the conveyance of the recording medium, hold of the image formed on the layer, and enhancement of the adhesion strength of the powder particles, it is preferable that the pressing force is within the range of 1 to 30 kPa with respect to the surface of the resin image layer, and the pressing force is smaller than the pressing force in the orientation adjustment step.

The rubbing member may be a rotating member or a non-rotating member such as a reciprocating member or a fixed member. The rubbing member may be a member movable relative to the surface of the resin image layer having a horizontal surface in the horizontal direction in contact with the surface, or may be a rotatable roller in contact with the surface of the resin image layer.

### <Powder Removing Step>

The image forming method of the present invention may further include a powder removing step after the powder supply step or after the rubbing step performed. In the powder removing step, the powder not adhering to the resin image layer is removed from the recording medium. At this time, the powder removed from the recording medium may be recovered and reused. That is, the image forming method of the present invention may further contain a powder recovering step to recover the powder that did not adhere to the resin image layer after the powder supply step or the rubbing step or the rubbing step. In this way, it is preferable to recover excess powder that has not been used for decoration from the viewpoint of economy and reducing the environmental load.

The method for removing or recovering the powder is not particularly limited, and may be performed by a known method. Examples thereof are: a method of scraping with a member such as a brush; a method of removing with an adhesive member such as an adhesive tape; and a method of sucking with a known device such as a powder collector capable of sucking or adsorbing powder. Thus, as the powder removing device (member) or the powder recovering device (member) for performing the powder removing step or the powder recovering step, as described above, it is possible to use a member such as a brush, an adhesive member having adhesiveness to powder, and a dust collector having a suction member for sucking powder. When the powder is a magnetic powder, a powder collector having a magnet member may be used.

### <Additional Printing Step>

The image forming method of the present invention may further include an additional printing step after the powder supply step, the rubbing step, the pressing step and/or the powder removing step. In the additional printing step, an image is further formed on a recording medium having the resin image layer (that is, a gloss image that has already been decorated). The additional printing method is not particularly limited, and a known method may be used. For example, a printing method such as an ink-jet method or an electrophotographic method may be used. In addition, a known device may be used as a printing device for performing the additional printing step. From the viewpoint of further improving the added value of the printed matter, it is preferable to further carry out the additional printing step.

### <Fixing Step>

In the image forming method of the present invention, after the powder supply step, the rubbing step, the pressing step, the powder removing step and/or the additional printing step, it is also preferable to contain a fixing step when needed. As an example of the fixed image forming method, a method may be adopted in which heat and pressure are applied by the fixing means to the recording medium to which the toner image has been transferred, and the toner image on the recording medium is fixed on the recording medium.

Further, it is preferable that the fixing step is performed by light irradiation. The irradiation conditions may be adjusted suitably.

### <Powder Particles>

The shape of the powder particles used in the image forming method of the present invention is not particularly limited as long as it is a non-spherical shape. It is preferable that the powder particles having a non-spherical shape have a flat particle shape from the viewpoint of orienting and adhering the powder particles along the surface of the resin image layer. The “flat particle shape” of the powder particles of the non-spherical shape means as follows. When the maximum length in the powder particles of the non-spherical shape is a major axis, and the maximum length in the direction perpendicular to the major axis is a minor axis, the minimum length in the direction perpendicular to the major axis is a thickness, The “flat particle shape” is a shape having a ratio of the minor axis to the thickness of 5 or more.

The thickness of the powder particles is preferably in the range of 0.2 to 10 μm, and more preferably in the range of 0.2 to 3.0 μm, from the viewpoint of sufficiently exhibiting the appearance effect due to the oriented adhesion of the powder particles. When the thickness is too small, the plane direction of the powder particles including the major axis direction and the minor axis direction of the powder particles adhering to the surface of the resin image layer substantially along the surface direction of the resin image layer in good orientation state of the powder particles may not be sufficiently formed. When the thickness is too large, powder particles may be removed when the image is rubbed.

The material of the powder particles is not limited. It is preferable that the powder particles have a metallic luster from the viewpoint of expressing a metallic luster feeling and a glitter feeling as a desired appearance of the final image. Metal powders are preferred, or metal oxide powders are preferred. The powder particles may be used by mixing particles of two or more materials having different materials. The powder may be coated, for example, a metal powder whose surface is coated with a metal oxide or a resin, a metal oxide powder whose surface is coated with a resin or a metal, or a resin powder whose surface is coated with a metal, a metal oxide, or a resin powder whose surface is coated with a metal, a metal oxide, or a resin.

The powder particles may be synthetic products or commercially available products. Examples of the non-spherical powder particles include: Sunshine Baby Chrome Powder, Aurora powder, Pearl Powder (GG Corporation), ICEGEL Mirror Metal Powder (TAT Corporation), PIKA ACE™ MC Shine Dust, Effect C (Kurachi Co., Ltd.), PREGEL™ Magic Powder, Mirror series (Preanfa Co., Ltd.), Bonnail™ Shine Powder (Kay's Planning, Inc.), and LG neo (Oike Imaging Co., Ltd.), METASHINE (Nippon Sheet Glass Co., Ltd.), and ST1025PS (Nippon Sheet Glass Co., Ltd.). All of these are non-spherical particles.

### <Recording Medium>

The resin image layer used in the image forming method of the present invention is formed on a recording medium. The recording medium may be appropriately selected from objects capable of carrying a resin image layer, and usually has a sheet shape, but the shape is not limited. Examples of the recording medium include plain paper from thin paper to thick paper, coated printing paper such as high-quality paper, art paper or coated paper, commercially available Japanese paper and postcard paper, plastic film and cloth. The color of the recording medium is not limited, and may be appropriately determined depending on, for example, the final image to be formed.

### <Resin Image Layer>

The resin image layer is not particularly limited as long as the powder particles may be adhered to the surface. For example, the resin image layer preferably contains a resin that is softened or plasticized by heating. In addition, it is preferable that the resin image layer is a color toner image layer formed with electrophotography, since the effects of the present invention may be remarkably exhibited. Examples of such a resin include a thermoplastic resin and a hot melt resin. In addition to the resin, other components such as a colorant, a dispersant, a surfactant, a plasticizer, a releasing agent, and an antioxidant may be contained in the layer.

The thermoplastic resin may be a known resin having thermoplasticity and is not particularly limited. Further, as the hot melt resin, a known resin having hot melt property may be used, and it is not particularly limited.

Examples of the thermoplastic resin and the hot melt resin include: (meth)acrylic resin, styrene resin, styrene-acrylic resin, olefin resin (including cyclic olefin resin), polyester resin, polycarbonate resin, polyamide resin, polyphenylene ether resin, polyphenylene sulfide resin, halogen-containing resin (polyvinyl chloride, poly vinylidene chloride, and fluorine resin), polysulfone resin (polyether sulfone and polysulfone), cellulose derivative (cellulose ester, cellulose carbamate, and cellulose ether), silicone resin (polydimethylsiloxane and polymethylphenyl siloxane), polyvinyl ester resin (polyvinyl acetate), acrylonitrile-butadiene-styrene copolymer (ABS resin), polyvinyl alcohol resin and derivatives thereof, rubber and elastomer (diene rubber such as polybutadiene and polyisoprene, styrene-butadiene copolymer, acrylonitrile-butadiene copolymer, acrylic rubber, and urethane rubber). The thermoplastic resin and the hot melt resin may be used alone or in combination of two or more. In the present specification, “(meth)acrylic” refers to “acrylic and/or methacrylic”.

The thermoplastic resin and the hot melt resin may be a copolymer. When the thermoplastic resin is a copolymer, the form of the copolymer may be any of a block copolymer, a random copolymer, a graft copolymer, and an alternating copolymer.

Further, as the thermoplastic resin and the hot melt resin, a synthetic product may be used or a commercially available product may be used. The polymerization method for synthesizing these thermoplastic resin and hot melt resin is not particularly limited, and known methods may be used. For example, high pressure radical polymerization method, medium and low pressure polymerization method, solution polymerization method, slurry polymerization method, bulk polymerization method, emulsion polymerization method, and gas phase polymerization method may be mentioned. Also, the radical polymerization initiator and catalyst used during polymerization are not particularly limited. For example, radical polymerization initiators such as azo or diazo polymerization initiators and peroxide polymerization initiators; polymerization catalysts such as peroxide catalysts, Ziegler-Natta catalysts, and metallocene catalysts may be used.

From the viewpoint of easily controlling the surface state of the resin image layer, the thermoplastic resin and the hot melt resin contain, among the above-mentioned resins, at least one selected from the group consisting of (meth) acrylic resin, styrene resin, styrene-acrylic resin, and polyester resin. More preferably, they contains at least one selected from the group consisting of styrene-acrylic resin and polyester resin.

The styrene-acrylic resin, as referred to in the present invention, is formed by polymerization using at least a styrene monomer and a (meth)acrylate monomer. In this specification, the styrene monomer indicates styrene represented by the formula CH₂═CH—C₆H₅, and also includes monomers having a known side chain or functional group in a styrene structure.

Moreover, a (meth)acrylate monomer is a monomer having a functional group which has an ester bond in a side chain. Specifically, in addition to an acrylate monomer represented by CH₂═CHCOOR (R is an alkyl group), a vinyl ester compound such as a methacrylate monomer represented by CH₂═C(CH₃)COOR (R is an alkyl group) is included.

In the styrene-acrylic resin, besides the copolymer formed only of the above-mentioned styrene monomer and (meth)acrylate monomer, copolymers formed using further common vinyl monomers (olefins, vinyl esters, vinyl ethers, vinyl ketones, and N-vinyl compounds) are included.

Further, in the styrene-acrylic resin, copolymers formed with a multifunctional vinyl monomer and a vinyl monomer having an ionic dissociative group (a carboxy group, a sulfonic acid group, or a phosphoric acid group) in a side chain in addition to a styrene monomer, a (meth)acrylate monomer and other common vinyl monomer. Examples of such vinyl monomers include, for example, acrylic acid, methacrylic acid, maleic acid, and itaconic acid.

The polyester resin is a known polyester resin obtained by the polycondensation reaction of a divalent or higher valent carboxylic acid (polyvalent carboxylic acid component) and an alcohol having a divalent or higher valent (polyhydric alcohol component). The polyester resin may be amorphous or crystalline. The number of valences of the polyvalent carboxylic acid component and the polyhydric alcohol component is preferably 2 to 3, and particularly preferably it is respectively 2. Therefore, the case where the valence number is 2 (i.e., the dicarboxylic acid component and the diol component) will be described as a particularly preferred embodiment. Examples of the dicarboxylic acid component include: saturated aliphatic dicarboxylic acids such as oxalic acid, malonic acid, succinic acid, glutaric acid, adipic acid, pimelic acid, suberic acid, azelaic acid, sebacic acid, 1,9-nonanedicarboxylic acid, 1,10-decanedicarboxylic acid (dodecanedioic acid), 1,11-undecanedicarboxylic acid, 1,12-dodecanedicarboxylic acid, 1,13-tridecanedicarboxylic acid, 1,14-tetradecanedicarboxylic acid, 1,16-hexadecanedicarboxylic acid, and 1,18-octadecanedicarboxylic acid; unsaturated aliphatic dicarboxylic acids such as methylenesuccinic acid, fumaric acid, maleic acid, 3-hexendiodic acid, 3-octendioic acid, and dodecenyl succinic acid; and unsaturated aromatic dicarboxylic acids such as phthalic acid, terephthalic acid, isophthalic acid, t-butyl isophthalic acid, tetrachlorophthalic acid, chlorophthalic acid, nitrophthalic acid, p-phenylenediacetic acid, 2,6-naphthalenedicarboxylic acid, 4,4′-biphenyldicarboxylic acid, and anthracene dicarboxylic acid. In addition, lower alkyl esters and acid anhydrides of these compounds may also be used. The dicarboxylic acid components may be used alone or in combination of two or more.

In addition, trivalent or higher polyvalent carboxylic acids such as trimellitic acid and pyromellitic acid, anhydrides of the above carboxylic acid compounds, and alkyl esters having 1 to 3 carbon atoms may also be used.

Examples of the diol component include: saturated aliphatic diols such as ethylene glycol, 1,2-propanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, 1,20-eicosandiol, and neopentyl glycol; unsaturated aliphatic diols such as 2-butene-1,4-diol, 3-butene-1,4-diol, 2-butyne-1,4-diol, 3-butyne-1,4-diol, and 9-octadecene-7,12-diol; aromatic diols such as bisphenols (bisphenol A and bisphenol F), and alkylene oxide adducts of these compounds (ethylene oxide adduct and propylene oxide adduct), and derivatives thereof. The diol components may be used alone or in combination of two or more. The method for producing the polyester resin is not particularly limited, and examples thereof include a method of polycondensation (esterification) of the polyvalent carboxylic acid component and the polyhydric alcohol component using a known esterification catalyst.

The weight average molecular weight of the resin contained in the resin image layer is not particularly limited, but is preferably in the range of 2,000 to 1,000,000, more preferably in the range of 5,000 to 100,000, and particularly preferably in the range of 10,000 to 50,000.

### (Weight Average Molecular Weight (Mw), Number Average Molecular Weight (Mn))

The resin to be measured was dissolved in tetrahydrofuran (THF) to a concentration of 1 mg/mL, and then filtered using a membrane filter with a pore size of 0.2 μm, and the resulting solution was used as a sample for GPC measurement. GPC analysis conditions indicated below were adopted for the GPC measurement conditions, and a weight average molecular weight or a number average molecular weight of resin contained in a sample were measured.

### <GPC Measurement Conditions>

As a GPC apparatus, “HLC-8120GPC, SC-8020” (made by Tosoh Corporation) was used. Two pieces of “TSKgel, Super HM-H” (6.0 mmID×15 cm, made by Tosoh Corporation) were used as columns Tetrahydrofuran (THF) was used as an eluent. The analysis was performed at a flow rate of 0.6 mL/min, a sample injection amount of 10 μL, and a measurement temperature of 40° C. using a RI detector. The calibration curve was obtained by using “Polystyrene standard sample, TSK standard” manufactured by Tosoh Corporation. Ten samples of “A-500”, “F-1”, “F-10”, “F-80”, “F-380”, “A-2500”, “F-4”, “F-40”, “F-128” and “F-700” were use. The data collection interval in sample analysis was 300 ms.

The content of the resin in the resin image layer is not particularly limited. From the viewpoint of softening the surface of the resin image layer to facilitate control of the surface state of the resin image layer, it is preferable that the content of the resin is in the range of 0 to 95 mass % with respect to the total mass of the resin image layer. More preferably, it is in the range of 0 to 50 mass %, still more preferably, it is in the range of 5 to 50 mass %, and most preferably, it is in the range of 10 to 50 mass %.

On the other hand, when the resin image layer contains other components (for example, a colorant and a releasing agent) together with the resin, the content of the other components is not particularly limited. From the viewpoint of melting or softening the surface of the resin image layer to facilitate control of the surface state of the resin image layer, it is preferable that the content of the other components is in the range of 3 to 40 mass % with respect to the total mass of the resin image layer. More preferably, it is in the range of 5 to 20 mass %.

The colorant as the other component is not particularly limited, and known dyes and pigments may be used. Examples of the colorant include: carbon black, magnetic material, and iron-titanium complex oxide black; dyes such as C. I. Solvent Yellow 19 and 44; pigments such as C. I. Pigment Yellow 14 and 17; dyes such as C. I. Solvent Red 1 and 49; pigments such as C. I. Pigment Red 5 and 122; dyes such as C. I. Solvent Blue 25 and 36; and pigments such as C. I. Pigment Blue 1 and 7. The colorants are not limited to them.

The releasing agent as the other component is not particularly limited, and a known releasing agent may be used. Examples of the releasing agent include: polyolefin waxes such as polyethylene wax and polypropylene wax; branched hydrocarbon waxes such as microcrystalline wax; long-chain hydrocarbon waxes such as paraffin wax and SASOL wax; dialkyl ketone waxes such as distearyl ketone; ester waxes such as carnauba wax, montan wax, behenyl behenate, trimethylolpropane tribehenate, pentaerythritol tetrabehenate, pentaerythritol diacetate dibehenate, glycerol tribehenate, 1,18-octadecanediol distearate, tristearyl trimellitate, and distearyl maleate; and amide waxes such as ethylenediaminebehenylamide and trimellitic tristearylamide. The present invention is not limited to them.

The thickness of the resin image layer is not particularly limited, and it is preferably, for example, in the range of 1 to 100 μm, and more preferably in the range of 1 to 50 μm. When the thickness of the resin image layer is in the above range, the orientation of the powder may be more easily controlled, and the texture may be easily controlled.

### [Image Forming Apparatus]

The image forming apparatus used in the image forming method of the present invention may have a means for adjusting the orientation of the powder particles, and for example, an embodiment added to the electrophotographic toner image forming apparatus 2 as the decoration apparatus 3 will be described below.

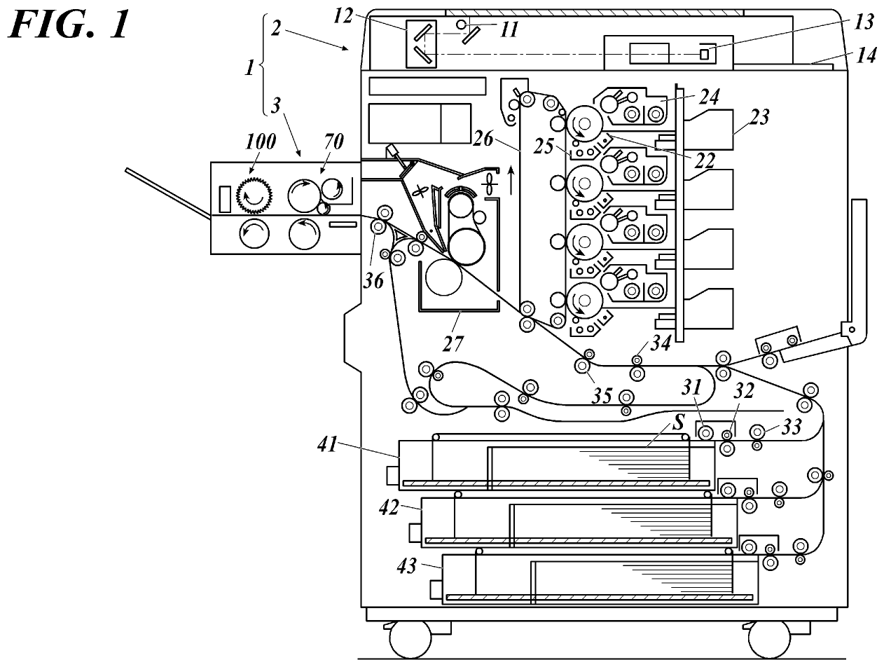

As shown in FIG. 1, the image forming system 1 includes a toner image forming apparatus 2 and a decoration apparatus 3. The toner image forming apparatus 2 has the same configuration as a known color printer, and includes, for example, an image reading unit, an image forming unit, a paper conveying unit, a sheet feeding unit, a control unit, and a fixing unit 27.

The image reading unit includes a light source 11, an optical system 12, an image pickup device 13, and an image processing unit 14.

The image forming unit includes an image forming unit Y that forms an image made of yellow (Y) toner, an image forming unit M that forms an image made of magenta (M) toner, an image forming unit C that forms an image made of cyan (C) toner, an image forming unit K that forms an image made of black (K) color toner, and an intermediate transfer belt 26. Note that Y, M, C, and K represent colors of toner.

Image forming unit Y includes a photoreceptor drum 21 as a rotating body, and a charging unit 22, an optical writing unit 23, a developing unit 24, and a drum cleaner 25 which are arranged around the photoreceptor drum 21. The image forming units M, C, and K also have the same configuration as the image forming unit Y. The intermediate transfer belt 26 is wound around a plurality of rollers and supported so as to be able to travel.

The paper conveying unit includes a feeding roller 31, a discharging roller 32, a conveying roller 33, a loop roller 34, a registration roller 35, a paper discharging roller 36, and a paper reversing unit 37. The sheet feeding unit includes a plurality of sheet feeding trays 41, 42, and 43 for accommodating sheets S.

The control unit has a CPU (Central Processing Unit), a RAM (Random Access Memory), and a ROM (Read Only Memory). The CPU controls an image reading apparatus, an image forming unit, a paper transport unit, a paper feed unit, and a decoration apparatus 3 in accordance with a program stored in the ROM, and stores the calculation result in the RAM. The control unit analyzes the print data received from the outside, generates image data in a bitmap format, and performs control to form an image based on the image data (the resin image layer 201) on the sheet S.

As shown in FIG. 2, the decoration apparatus 3 includes a powder supply rubbing section 70, a heating member 80 (heating section), an orientation adjustment unit 100, and a powder removing unit 90.

The powder supply rubbing section 70 is a device for supplying the powder particles 200 onto the resin image layer 201 formed by the toner image forming apparatus 2 as a supply means of the powder particles 200. The powder supply rubbing section 70 includes a container 71 for accommodating the powder particles 200, a first supply roller 72 for conveying the powder particles 200 to the opening of the container 71, a transfer roller 73 for taking out the powder particles 200 from the container 71 and transferring the powder particles oriented by the roller member 74 onto the resin image layer 201 together with the opposing roller 75, a roller member 74 for rubbing the powder particles 200 held by the transfer roller 73 along the surface of the transfer roller 73 to form a thin layer of the powder particles 200, and an opposing roller 75 disposed opposite the transfer roller 73 and conveying the paper S. The powder particles 200 have the aforementioned non-spherical shape, and preferably have a flat particle shape.

The opening of the container 71 is formed in a size to contact the surface of the transfer roller 73 in order to regulate the amount of the powder particles 200 held by the transfer roller 73. The roller member 74 is disposed at a position in contact with the transfer roller 73. The amount of biting of the roller member 74 into the transfer roller 73 may be determined in consideration of, for example, the supply amount of the powder particles 200.

The roller member 74 may be fixed at a position in contact with the transfer roller 73, or the roller member 74 may be configured to be movable so that the roller member 74 is separated from the transfer roller 73 when the transfer roller 73 stops.

The transfer roller 73 is supplied from the first supply roller 72 and is rubbed by the roller member 74 to supply a thin layer of the powder particles 200 oriented along the surface onto the resin image layer 201. The transfer roller 73 has a rotation shaft in a direction perpendicular to the conveying direction of the paper S (a direction perpendicular to the paper surface), it is configured to be rotatable in a direction of an arrow in the drawing, and is configured to be biased by a biasing member (not shown). The transfer roller 73 has, for example, a cylindrical core metal and an elastic layer such as a resin sponge disposed on the outer peripheral surface thereof. The length of the transfer roller 73 in the axial direction is longer than the width of the paper S.

The opposed roller 75 is provided so as to face the transfer roller 73, and conveys the paper S provided with the resin image layer 201 in the conveying direction.

The heating member 80 heats and softens the resin image layer 201. The heating member 80 is preferably disposed on the upstream side of the transfer roller 73 in the conveying direction, but may be disposed on the downstream side. The heating member 80 is preferably disposed so as to heat the surface on the side of the paper S, and a hot plate, for example, is used as the heating member 80.

The orientation adjustment unit 100 preferably includes a pressing member 101 and an opposing member 102 disposed to face the pressing member 101, and adjusts the orientation of the powder particles 200 rubbed by the transfer roller 73 in the resin image layer 201 by the pressing member 101 and the opposing member 102.

The pressing member 101 presses the resin image layer 201. Preferably, the difference in velocity between the pressing member and the image surface is substantially zero. However, when it is judged necessary from the viewpoint of paper conveyance, a slight difference in speed may be made.

As described above, it is preferable that the pressing member 101 has a surface shape such that the average height Rc of the roughness curve element is in the range of 0.005 to 2.000 mm, and the average length RSm of the roughness curve element is in the range of 0.005 to 2.000 mm.

The pressing member 101 according to the present invention is not particularly limited, and may be appropriately selected from various materials such as metal, resin, wood, stone, cloth, paper, and ceramic, or composite materials thereof. A coating layer such as a releasing agent or an antistatic agent may be applied to the surface of the pressing member 101.

The opposing member 102 is provided to face the pressing member 101, and adjusts the orientation of the powder particles 200 on the resin image layer 201 by pressing the surface of the resin image layer 201 between the pressing member 101 and the opposing member 102. The paper S provided with the resin image layer 201 is conveyed in the conveying direction by the facing member 102.

The powder removing unit 90 is preferably, for example, a powder collector for suctioning excess powder particles 200 out of the powder particles 200 supplied from the first supply roller 72. The powder collector is disposed so that the suction opening is opened at a position at an appropriate height from the conveying path of the paper S, and is preferably configured to operate at an appropriate output for sucking the powder particles 200 but not sucking the sheet S, for example. In addition to the powder collector, the powder removing unit 90 may be provided with a cleaning member for removing the excess powder particles 200 on the resin image layer 201 after pressing the powder particles 200 against the resin image layer 201. Examples of the cleaning member include an adhesive rubber roller.

In the image forming system 1, the control unit controls the image reading unit, the image forming unit, the paper conveying unit, the sheet feeding unit, and the decoration apparatus 3.

In the image reading unit, the light irradiated from the light source 11 is irradiated onto the document placed on the reading surface, and the reflected light is imaged onto the image pickup device 13 moved to the reading position through the lens and the reflecting mirror of the optical system 12. The image pickup device 13 generates an electric signal in accordance with the intensity of the reflected light from the document. The generated electric signal is converted from an analog signal to a digital signal in the image processing unit 14, and then subjected to correction processing, filter processing, or image compression processing, and is stored in the memory of the image processing unit 14 as image data. Thus, the image reading unit reads the image of the document and stores the image data.

In the image forming unit, the photoreceptor drum 21 rotates at a predetermined speed by a drum motor. The charging unit 22 charges the surface of the photoreceptor drum 21 to a desired potential, and the optical writing unit 23 writes the image information signal to the photoreceptor drum 21 based on the image data, and forms a latent image based on the image information signal on the photoreceptor drum 21. The latent image is then developed by the developing unit 24, and a toner image that is a visible image is formed on the photoreceptor drum 21. In this manner, unfixed toner images of yellow, magenta, cyan, and black toner images are formed on the photoreceptor drums 21 of the respective image forming portions of YMCK. Thus, the image forming unit forms a toner image using an electrophotographic image forming process.

The toner images of the respective colors formed by the respective image forming units of YMCK are sequentially transferred onto the running intermediate transfer belts 26 by the primary transfer units. Thus, on the intermediate transfer belt 26, a color toner image is formed in which toner layers of respective colors of yellow, magenta, cyan, and black are superimposed.

In the paper conveying unit, the paper S is conveyed one by one from the paper feed trays 41, 42, and 43 of the sheet feeding unit by the feeding roller 31 and the discharging roller 32. The paper S fed to the conveying path is conveyed to the secondary transfer roller through the loop roller 34 and the registration roller 35 along the conveying path by the conveying roller 33. Then, the color toner image on the intermediate transfer belt 21 is transferred onto the paper S.

When heat and pressure are applied to the paper S to which the color toner image has been transferred by the fixing unit 27, the color toner image on the sheet S is fixed to the sheet S as a color toner layer. Thus, the resin image layer 201 is formed on the paper S. The paper S having the resin image layer 201 is sent to the decoration apparatus 3 via the sheet discharge roller 36.

The fixed paper S may be guided to the paper reversing unit 37 and discharged by reversing the front and back sides of the sheet S. Thus, images may be formed on both sides of the paper S.

When sent to the decoration apparatus 3, in the powder supply rubbing unit 70, the powder particles 200 contained in the container 71 is conveyed to the transfer roller 73 by the first supply roller 72. The transfer roller 73 rotates clockwise (opposite to the rotation direction of the first supply roller 71) as shown in the drawing, for example, and captures the powder particles 200. The powder particles 200 captured by the transfer roller 73 are formed on the surface of the transfer roller 73 by the roller member 74 into a thin layer in which the powder particles 200 are oriented.

On the other hand, the paper S having the resin image layer 201 is heated from the back surface of the sheet S by the heating member 80 before the powder particles 200 are supplied. By this heating, the resin image layer 201 is moderately softened, and an adhesive force is generated on the surface of the resin image layer 201.

The transfer roller 73 is urged toward the paper S and rotates in the direction described above. The transfer roller 73 rotates while pressing the powder particles 200 on the resin image layer 201 with an appropriate force (for example, about 10 kPa) and supplies a thin layer in which the powder particles 200 are oriented between the transfer roller 73 and the opposing roller 75, and transfers the thin layer onto the surface of the resin image layer 201 to which the powder particles 200 are supplied. Since the surface of the resin image layer 201 has adhesiveness and the powder particles 200 are supplied and transferred by the transfer roller 73, the powder particles 200 are arranged and adhered to the surface of the resin image layer 201 in the direction along the surface in the thin layer state.

Here, the powder particle 200 has a non-spherical shape, and preferably has a flat shape. Therefore, the powder particles 200 are easily arranged along a plane (a plane perpendicular to the thickness direction) including a major axis and a minor axis. In addition, the powder particles 200 on the resin image layer 201 are transferred while being appropriately pressed by the transfer roller 73.

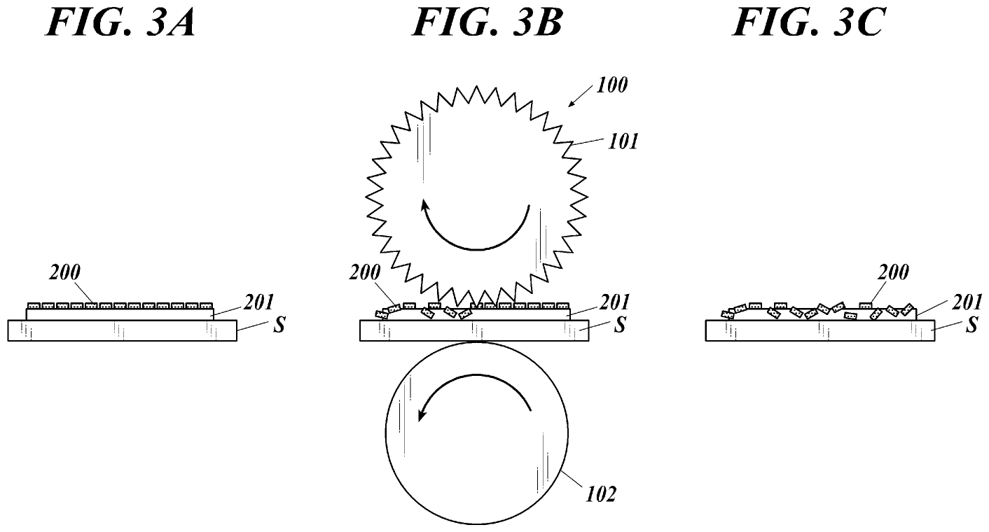

In addition, a portion which is not in direct contact with the resin image layer 201 remains on the transfer roller 73 without being transferred when transferred from the transfer roller 73. For this reason, as shown in FIG. 3A, the thin layer of the powder particles 200 is arranged along the surface of the resin image layer 201 and adhered on the surface.

The thin layer of the powder particles 200 arranged and adhered in this mariner is further disturbed by the pressing member 101 in the orientation of the powder particles 200. The desired orientation, i.e., the half-value width of the reflected light distribution is adjusted to be hd1<hd2 (see FIG. 3B and FIG. 3C).

The paper S having the resin image layer 201 supplied with the powder particles 200 is cooled to room temperature, for example, and the powder particles 200 are fixed on the resin image layer 201, so that an image having the sheet S, the resin image layer 201, and the thin layer of the powder particles 200 in this order is finally formed.

The powder particles 200 may slightly migrate electrostatically or for some reason to an area where the resin image layer 201 is not to be transferred. These powder particles 200 are removed from the resin image layer 201 by the cleaning member, or are sucked into the powder collector by the flow of air by the powder collector, and are removed from the paper S, the resin image layer 201, and the conveyance path.

As described above, the thin layer of the powder particles 200 adheres to the surface of the resin image layer 201, and the orientation of the powder particles 200 is further adjusted by the above-mentioned pressing, and in particular, only the powder particles 200 exhibiting the adhesive force due to the adhesiveness of the resin image layer 201 adhere to the resin image layer 201 and remain on the above-mentioned surface.

Thus, the powder particles 200 adhere to the surface of the resin image layer 201 through the above-described processes. The surface of the resin image layer 201 is not entirely covered with the powder particles 200. For example, it is preferable that the concealment ratio of the surface by the powder particles 200 is about 30 to 80%.

Therefore, in the final image, the appearance of a glitter feeling or a granular feeling is obtained as the appearance in which the visual effect of the layer of the powder particles 200 and the visual effect of the image of the paper S and the toner layer are combined.

The appearance of the final image is controlled by the combination of the appearance of the powder particles and the saturation of the underlying image. For example, when the powder particles are powder particles having metallic luster, a silver glitter tone image tends to be obtained when the background image is achromatic, and a glitter image reflecting the tone of the background image tends to be obtained when the background image is highly saturated.

In the illustrated embodiment, the image forming apparatus (decoration apparatus) is combined with an electrophotographic color printer (toner image forming apparatus 2), but may be composed only of the image forming apparatus. Alternatively, the image forming apparatus may be incorporated in the color printer and configured integrally with the color printer.

Although the embodiments of the present invention have been described and illustrated in detail, the disclosed embodiments are made for purpose of illustration and example only and not limitation. The scope of the present invention should be interpreted by terms of the appended claims

### EXAMPLES

Hereinafter, the present invention will be described in detail with reference to examples, but the present invention is not limited thereto. In the examples below, the operation was performed at room temperature (25° C.) unless otherwise specified. Also, unless otherwise specified, “%” and “parts” mean “mass %” and “parts by mass” respectively.

### [Preparation of Toner]

### (1) Preparation of Colorant Particle Dispersion Liquid

11.5 parts by mass of sodium n-dodecyl sulfate was added to 160 parts by mass of ion-exchanged water, and it was dissolved and stirred to prepare an aqueous surfactant solution. In this aqueous surfactant solution, 15 parts by mass of a colorant (carbon black: MOGUL™ L) was gradually added, and dispersion treatment was performed using “CLEARMIX W Motion CLM-0.8” (M Technique Co., Ltd.). Thus, a colorant particle dispersion liquid was prepared. The particle size of the fine particles of the colorant in the colorant particle dispersion liquid was 220 nm in terms of volume-based median diameter. The volume-based median diameter was determined by measurement using “MICROTRAC UPA-150” (manufactured by HONEYWELL Co. Ltd.) under the following measurement conditions.

Sample refractive index: 1.59

Sample specific gravity: 1.05 (in terms of spherical particles)

Solvent refractive index: 1.33

Solvent viscosity: 0.797 (30° C.), 1.002 (20° C.)

0 point adjustment: Ion-exchanged water was added to the measurement cell for adjustment.

### (2) Manufacturing Process of Core Resin Particles

The resin particles for the core portion having a multilayer structure were produced through the following first stage polymerization, second stage polymerization and third stage polymerization.

### (a) First Stage Polymerization

A reaction vessel equipped with a stirrer, a temperature sensor, a cooling tube, and a nitrogen introducing device was charged with a surfactant solution prepared by dissolving 4 parts by mass of sodium polyoxyethylene-2-dodecyl ether sulfate in 3040 parts by mass of ion-exchanged water. The internal temperature was raised to 80° C. while stirring at a stirring speed of 230 rpm under a nitrogen stream. A polymerization initiator solution prepared by dissolving 10 parts by mass of potassium persulfate in 400 parts by mass of ion-exchanged water was added to the above aqueous solution of a surfactant, and the temperature was raised to 75° C., and then a monomer mixture composed of the following compound was added dropwise to the reaction vessel over 1 hour.

Styrene: 532 parts by mass

n-Butyl acrylate: 200 parts by mass

Methacrylic acid: 68 parts by mass

N-Octyl mercaptan: 16.4 parts by mass

After the above monomer mixture was added dropwise, the system was heated at 75° C. for 2 hours and stirred to carry out polymerization (first stage polymerization) to produce resin particles (A1).

### (b) Second Stage Polymerization

Into a flask equipped with a stirrer, a monomer mixture liquid containing the following compounds was charged, and 93.8 parts by mass of paraffin wax “HNP-57” (manufactured by Nippon Seiro Co., Ltd.) was added as a release agent, and the temperature was raised to 90° C. to dissolve it.

Styrene: 101.1 parts by mass

N-Butyl acrylate: 62.2 parts by mass

Methacrylic acid: 12.3 parts by mass

N-octyl mercaptan: 1.75 parts by mass

On the other hand, an aqueous surfactant solution was prepared by dissolving 3 parts by mass of sodium polyoxyethylene-2-dodecyl ether sulfate in 1560 parts by mass of ion-exchanged water, and heated to 98° C. 32.8 parts by mass (in terms of solid content) of resin particles (A1) was added to this aqueous surfactant solution. Furthermore, after adding the above-mentioned paraffin wax-containing monomer mixed solution, the mixture was mixed and dispersed for 8 hours by a mechanical disperser “CLEARMIX” (manufactured by M Technique Co., Ltd.) having a circulation path. An emulsified particle dispersion liquid containing emulsified particles having a dispersed particle diameter of 340 nm was prepared by mixing and dispersing. Then, a polymerization initiator solution prepared by dissolving 6 parts by mass of potassium persulfate in 200 parts by mass of ion-exchanged water was added to the emulsion particle dispersion, and the system was heated and stirred at 98° C. for 12 hours for polymerization. Second stage polymerization was performed to prepare resin particles (A2).

### (c) Third Stage Polymerization

A polymerization initiator solution prepared by dissolving 5.45 parts by mass of potassium persulfate in 220 parts by mass of ion-exchanged water was added to the resin particles (A2). A monomer mixture of the following compounds was added dropwise under a temperature condition of 80° C. over 1 hour.

Styrene: 293.8 parts by mass

N-Butyl acrylate: 154.1 parts by mass

N-octyl mercaptan: 7.08 parts by mass

After completion of dropping, the mixture was heated and stirred for 2 hours to carry out polymerization (third stage polymerization), and after completion of the polymerization, it was cooled to 28° C. to prepare resin particles for core portion.

### (3) Manufacturing Process of Shell Resin Particles

The polymerization reaction and the post-reaction process were out in the same manner as described for the core resin panicles except that the monomer mixed solution used in the first stage polymerization in the preparation of the resin panicles for the core portion was changed to the following one to prepare resin particles for the shell.

Styrene: 624 parts by mass

2-Ethylhexyl acrylate: 120 parts by mass

Methacrylic acid: 56 parts by mass

n-Octyl mercaptan: 16.4 parts by mass

(4) Manufacturing process of black toner particles
(a) Preparation of core portion

Into a reaction vessel equipped with a stirrer, a temperature sensor, a cooling tube, and a nitrogen introducing device were added the following components in the following amounts and stirred. After adjusting the temperature of the obtained mixed solution to 30° C., a 5 mol/liter aqueous sodium hydroxide solution was added to the mixed solution to adjust its pH in the range of 8 to 11.

Core resin particles: 420.7 parts by mass (solid content)

Ion-exchanged water: 900 parts by mass

Black dispersion liquid: 300 parts by mass

Next, an aqueous solution containing 2 parts by mass of magnesium chloride hexahydrate dissolved in 1000 parts by mass of ion-exchanged water was added at 30° C. for 10 minutes with stirring. After leaving still for 3 minutes, the temperature of the mixture was raised, the system was heated to 65° C. for 60 minutes, and the particle growth reaction was continued. In this state, the particle size of the associated particles was measured with “Multisizer 3” (manufactured by Colter, Inc.), and when the volume-based median diameter became 5.8 μm, an aqueous solution containing 40.2 parts by mass of sodium chloride dissolved in 1000 parts by mass of ion-exchange water was added to stop particle growth. After the association was stopped, the core portion was produced by continuing the fusion of the associated particles by heating and stirring for 1 hour at a liquid temperature of 70° C. as an aging treatment. When the average circularity of the core portion was measured by “FPIA2100” (manufactured by Sysmex Corporation, “FPIA” is a registered trademark of the company), it was 0.912.

### (b) Preparation of Shell Portion

Next, the mixed solution was heated to 65° C., and 50 parts by mass (solid content) of shell resin particles were added to the mixed solution, and further, an aqueous solution containing 2 parts by mass of magnesium chloride hexahydrate dissolved in 1000 parts by mass of ion-exchanged water was added to the above mixture over 10 minutes. Thereafter, the mixture was heated to 70° C. and stirred for 1 hour. In this mariner, the shell resin panicles were fused to the surface of the core portion, and then aged at 75° C. for 20 minutes to film a shell. Then, an aqueous solution containing 40.2 parts by mass of sodium chloride dissolved in 1000 parts by mass of ion-exchange water was added to stop shell formation. Further, it was cooled to 30° C. at a rate of 8° C./min. The produced particles were filtered, washed repeatedly with ion-exchanged water at 45° C., and then dried with hot air at 40° C., thereby producing black toner particles having a shell covering the surface of the core portion.

### (c) External Additive Addition Step

The following external additives were added to the black toner particles, and external addition processing was performed with “Henschel mixer” (manufactured by Nippon Coke & Engineering Co., Ltd.) to produce black toner particles.

Silica particles treated with hexamethylsilazane: 0.6 parts by mass

Titanium dioxide particles treated with N-octylsilane: 0.8 parts by mass

The external addition process using a Henschel mixer was performed under the conditions of a stirring blade peripheral speed of 35 m/sec, a processing temperature of 35° C., and a processing time of 15 minutes. A ferrite carrier having a volume average particle diameter of 40 μm coated with methyl methacrylate and cyclohexyl methacrylate resin was mixed with this black toner to prepare a black developer having a toner concentration of 6%.

### [Image Formation]

OK Topcoat +157 gsm manufactured by Oji Paper Co., Ltd. was used as a recording medium. AccurioPressC2060 was used as an output machine, and 2 cm×2 cm square patches were output using a black toner. Using a make-up puff, a silicone rubber sheet RBAM2-100 was rubbed and aligned with LG neo #325 SILVER manufactured by Oike Imaging Co., Ltd. The recording medium on which the image was formed was placed on a hot plate set at 120° C., and the powder surface of the silicone rubber sheet on which the powder particles were oriented was placed in a direction to contact the toner image, and the sheet was pressed at 200 kPa for 10 seconds using a roller, peeled off the silicon rubber sheet, then cooled. Using GP-5 manufactured by Murakami Color Research Institute, the reflected light distribution was measured at an incident angle of 45° and a light receiving angle of 0 to 90°, and the half-value width was calculated to be 2.8°.

### Example 1

An orientation adjustment step was performed on the image formed as described above by the following method. As the pressing member, a cloth file #60 (Rc=0.320 mm, RSm=1.117 mm) manufactured by Mitsui Chemicals, Inc. was used, and the abrasive grain surface of the file was overlaid so as to be in contact with the black image surface. By pressing at a temperature of 150° C. with 200 kPa for 10 seconds, the orientation of the powder particles was adjusted. When the half-value width of the reflected light distribution was measured, it was found to be 17.2°.

### Example 2

The orientation of the powder particles was adjusted in the same manner as in Example 1 except that the pressing member used was changed to a cloth file #320 (Rc=0.045, RSm=0.811) manufactured by Mitsui Rikagaku Co., Ltd.

### Example 3

The orientation of the powder particles was adjusted in the same manner as in Example 1 except that the heating temperature was changed to 130° C.

### Example 4

The orientation of the powder particles was adjusted in the same manner as in Example 1 except that the pressing force was changed to 150 kPa.

### Example 5

The orientation of the powder particles was adjusted in the same manner as in Example 1 except that the pressing time was changed to 7 seconds.

### Example 6

The image formed in Example 1 was sprayed with THF (tetrahydrofuran) to penetrate it. Then, using a hot plate, the back surface of the image was heated at 150° C. and completely dried to adjust the orientation of the powder particles.

### Example 7

The orientation of the powder particles was adjusted in the same manner as in Example 1 except that the powder particles used were changed to glass flakes ST1025FY manufactured by Nippon Sheet Glass Co., Ltd. The half-value width before the orientation adjustment step was 2.6°, and the half-value width after the orientation adjustment step was 17.0°.

### Comparative Example 1

The image formed in Example 1 was used as Comparative example 1 without performing the orientation adjustment step.

### [Evaluation]

<Glitter feeling (Graininess)>

10 skilled evaluators visually evaluated the images obtained in Examples 1 to 7 and Comparative example 1 and asked if they had a glitter feeling (granular gloss feeling). The evaluated images in which 8 or more out of 10 responded that they had a glitter feeling (granular gloss feeling) were regarded as acceptable. In addition, regarding Example 7, since it was not a powder having metallic luster, it was asked whether or not there was a granular feeling.

TABLE I

| | | | | | | | Half-value width of | | |
|---|---|---|---|---|---|---|---|---|---|
| | | Orientation adjustment step | | | | | Reflected light | | |
| | | | | | | Heating | distribution | | |
| | | | | | | and | Before | After | |
| | | Pressing | Rc of | RSm of | Heating | pressing | Orientation | Orientation | Glitter |
| | Powder | force | Pressing | Pressing | temperature | time | adjustment | adjustment | feeling |
| | particles | (kPa) | member | member | (° C.) | (sec) | step hd1 | step hd2 | (Graininess) |
| Example 1 | LG | 200 | 0.320 | 1.117 | 150 | 10 | 2.8° | 17.2° | 10 |
| | neo#325 | | | | | | | | |
| Example 2 | LG | 200 | 0.045 | 0.811 | 150 | 10 | 2.8° | 14.8° | 8 |
| | neo#325 | | | | | | | | |
| Example 3 | LG | 200 | 0.320 | 1.117 | 130 | 10 | 2.8° | 16.4° | 9 |
| | neo#325 | | | | | | | | |
| Example 4 | LG | 150 | 0.320 | 1.117 | 150 | 10 | 2.8° | 16.7° | 9 |
| | neo#325 | | | | | | | | |
| Example 5 | LG | 200 | 0.320 | 1.117 | 150 | 7 | 2.8° | 16.1° | 9 |
| | neo#325 | | | | | | | | |
| Example 6 | LG | Solvent spray penetration | | | 150 | 30 | 2.8° | 13.1° | 8 |
| | neo#325 | without pressing | | | | (Without | | | |
| | | | | | | pressing) | | | |
| Example 7 | ST1025SY | 200 | 0.320 | 1.117 | | 10 | 2.6° | 17.0° | 10 |
| | | | | | | | | | Persons who |
| | | | | | | | | | recognized |
| | | | | | | | | | Graininess |

| | | | | | |
|---|---|---|---|---|---|
| Comparative | LG | — | 2.8° | — | 0 |
| example 1 | neo#325 | | | | |

As shown in the above results, it can be seen that when the image forming method of the present invention is used, an image having a glitter feeling or a granular feeling can be formed as compared with the comparative example.

What is claimed is:

1. An image forming method for arranging powder particles on a resin image layer, wherein the powder particles are non-spherical powder particles; the image forming method comprising the step of adjusting an orientation of the powder particles disposed on the resin image layer; and hd1 and hd2 are adjusted so as to satisfy a relation expressed by the following Equation (1),
hd1<hd2, Equation (1):
wherein hd1 and hd2 each are respectively a half-value width of a reflected light distributions before and after the step of adjusting the orientation of the powder particles.

2. The image forming method described in claim 1, wherein the non-spherical powder particles are flat powder particles.

3. The image forming method described in claim 1, further comprising the step of supplying the powder particles onto the resin image layer formed on the recording medium.

4. The image forming method described in claim 1, wherein the resin image layer is a toner image layer formed by electrophotography.

5. The image forming method described in claim 1, further comprising the step of softening the resin image layer.

6. The image forming method described in claim 1, wherein the step of adjusting the orientation of the powder particles involves pressing.

7. The image forming method described in claim 1, wherein a surface shape of a pressing member used in the step of adjusting the orientation of the powder particles is such that an average height Rc of a roughness curve element is in the range of 0.005 to 2.000 mm, and an average length RSm of the roughness curve element is in the range of 0.005 to 2.000 mm.

8. The image forming method described in claim 1, wherein the powder particles have a metallic luster.
